(19) United States
(12) Patent Application Publication
(10) Pub. No.: US 2004/0003374 A1
(43) Pub. Date: Jan. 1, 2004

(54) Efficient computation of character offsets for token-oriented representation of program code

(76) Inventors: Michael L. Van De Vanter, Mountain View, CA (US); Kenneth B. Urquhart, Holly Springs, NC (US)

Correspondence Address: ZAGORIN O'BRIEN & GRAHAM, L.L.P., 7600B N. CAPITAL OF TEXAS HWY., SUITE 350, AUSTIN, TX, 78731, US

(21) Appl. No.: 10/185,753

(22) Filed: Jun. 28, 2002

(51) Int. Cl. G06F 9/44; G06F 15/00

(52) U.S. Cl. 717/112; 715/530; 715/531

(57) ABSTRACT

An editor, software engineering tool or collection of such tools may be configured to encode (or employ an encoding of) an insertion point in both token-coordinates and character-coordinates. Efficient implementations of insert, remove and replace operations that employ and maintain such a representation are described herein. Some realizations further maintain a total buffer size encoding consistent with each such operations. Computational costs of such operations typically scale at worst with the size of fragments inserted into and/or removed from such a token-oriented representation, rather than with buffer size. Accordingly, such implementations are particularly well-suited to providing efficient support for programming tool environments in which a token stream is updated incrementally in correspondence with user edits.

### CROSS-REFERENCE TO RELATED APPLICATION(S)

This application is related to commonly owned U.S. Patent Application Ser. No. XX/xxx,xxx {Atty. Docket No. 004-6205, entitled “TOKEN-ORIENTED REPRESENTATION OF PROGRAM CODE WITH SUPPORT FOR TEXTUAL EDITING THEREOF,” naming Van De Vanter and Urquhart as inventors and filed on even date herewith}, Ser. No. XX/xxx,xxx {Atty. Docket No. 004-6207, entitled “UNDO/REDO TECHNIQUE FOR TOKEN-ORIENTED REPRESENTATION OF PROGRAM CODE,” naming Van De Vanter and Urquhart as inventors and filed on even date herewith} and Ser. No. XX/xxx,xxx {Atty. Docket No. 004-6208, entitled “UNDO/REDO TECHNIQUE WITH INSERTION POINT STATE HANDLING FOR TOKEN-ORIENTED REPRESENTATION OF PROGRAM CODE,” naming Van De Vanter and Urquhart as inventors and filed on even date herewith}.

### BACKGROUND

1. Field of the Invention

The present invention relates generally to interactive software engineering tools including editors for source code such as a programming code or mark-up language, and more particularly to facilities for supporting edit operations on a token-oriented representation of code or content.

2. Description of the Related Art

In an editor for computer programs, it can be desirable to represent program code using a token-oriented representation, rather than simply as a linear sequence of characters. In such a representation, the linear sequence of characters that corresponds to program code may be divided into substrings corresponding to the lexical tokens of the particular language. In some implementations, this representation of a stream of tokens can updated incrementally after each user action (for example, after each keystroke) using techniques such as those described in U.S. Pat. No. 5,737,608 to Van De Vanter, entitled “PER KEYSTROKE INCREMENTAL LEXING USING A CONVENTIONAL BATCH LEXER.” In general, such updates may employ a facility that allows insertion and/or deletion of tokens in or from the token stream.

Such updates may be expressed in terms of particular token-coordinates positions in a token stream, referring to a particular token and location of a particular character in the token. Although some operations of an editor may be expressed in this way, other operations, particularly text-oriented operations or program state accesses employed by some programming tools such as compilers, source-level debuggers etc., may benefit from traversal of a program representation as if it were a text stream. What is needed is a representation that satisfies both requirements and can efficiently support frequently performed operations, such as insertion of tokens in and/or deletion of tokens from the stream.

### SUMMARY

It has been discovered that an editor, software engineering tool or collection of such tools may be configured to encode (or employ an encoding of) an insertion point in both token-coordinates and character-coordinates. Efficient implementations of insert, remove and replace operations that employ and maintain such a representation are described herein. Some realizations further maintain a total buffer size encoding consistent with each such operations. Computational costs of such operations typically scale at worst with the size of fragments inserted into and/or removed from such a token-oriented representation, rather than with buffer size. Accordingly, such implementations are particularly well-suited to providing efficient support for programming tool environments in which a token stream is updated incrementally in correspondence with user edits. These and other implementations will be understood with reference to the specification and claims that follow.

### BRIEF DESCRIPTION OF THE DRAWINGS

The present invention may be better understood, and its numerous objects, features, and advantages made apparent to those skilled in the art by referencing the accompanying drawings.

FIG. 1 depicts operation of one or more software engineering tools that operate on and/or maintain a tokenized program representation in accordance with some embodiments of the present invention.

FIGS. 2A and 2B illustrate, in accordance with some embodiments of the present invention, states of a tokenized program representation in relation to operations that insert tokens into the program representation, typically in response to user edits. In particular, FIGS. 2A and 2B illustrate states before and after an edit operation that inserts tokens into the representation.

FIGS. 3A and 3B illustrate, in accordance with some embodiments of the present invention, states of a tokenized program representation in relation to operations that remove tokens from the program representation, typically in response to user edits. In particular, FIGS. 3A and 3B illustrate states before and after an edit operation that removes tokens from the representation.

FIG. 4 illustrates, in accordance with some embodiments of the present invention, a portion of a tokenized program representation after both an insertion of tokens into the representation and partial deletion of thereof.

FIGS. 5A and 5B illustrate, in accordance with some embodiments of the present invention, states of a tokenized program representation in relation to operations that replace a first set of one or more tokens of the program representation with a second set, typically in response to user edits. In particular, FIGS. 5A and 5B illustrate states before and after an edit operation that replaces tokens in the representation.

FIG. 6 depicts interactions between various functional components of an exemplary editor implementation that employs a token-oriented representation and for which insertion point support may be provided in accordance with techniques of the present invention.

The use of the same reference symbols in different drawings indicates similar or identical items.

### DESCRIPTION OF THE PREFERRED EMBODIMENT(S)

Exploitations of the techniques of the present invention are many. In particular, a variety of software engineering tools are envisioned, which employ aspects of the present invention to facilitate edit and/or navigation operations on a token-oriented representation of program code. One exemplary software engineering tool is a source code editor that provides specialized behavior or typography based on lexical context using a tokenized program representation. Such a source code editor provides a useful descriptive context in which to present various aspects of the present invention. Nonetheless, the invention is not limited thereto. Indeed, applications to editors, analyzers, builders, compilers, debuggers and other such software engineering tools are envisioned. In this regard, some exploitations of the present invention may provide language-oriented behaviors within suites of tools or within tools that provide functions in addition to manipulation of program code.

In addition, while traditional procedural or object-oriented programming languages provide a useful descriptive context, exploitations of the present invention are not limited thereto. Indeed, other software engineering tool environments such as those adapted for editing, analysis, manipulation, transformation, compilation, debugging or other operations on functionally descriptive information or code, such as other forms of source code, machine code, bytecode sequences, scripts, macro language directives or information encoded using markup languages such as HTML or XML, may also employ structures, methods and techniques in accordance with the present invention. Furthermore, the structures, methods and techniques of the present invention may be exploited in the manipulation or editing of non-functional, descriptive information, such as software documentation or even prose. Based on the description herein, persons of ordinary skill in the art will appreciate applications to a wide variety of tools and language contexts.

Accordingly, in view of the above and without limitation, an exemplary exploitation of the present invention is now described.

Tokenized Program Representation

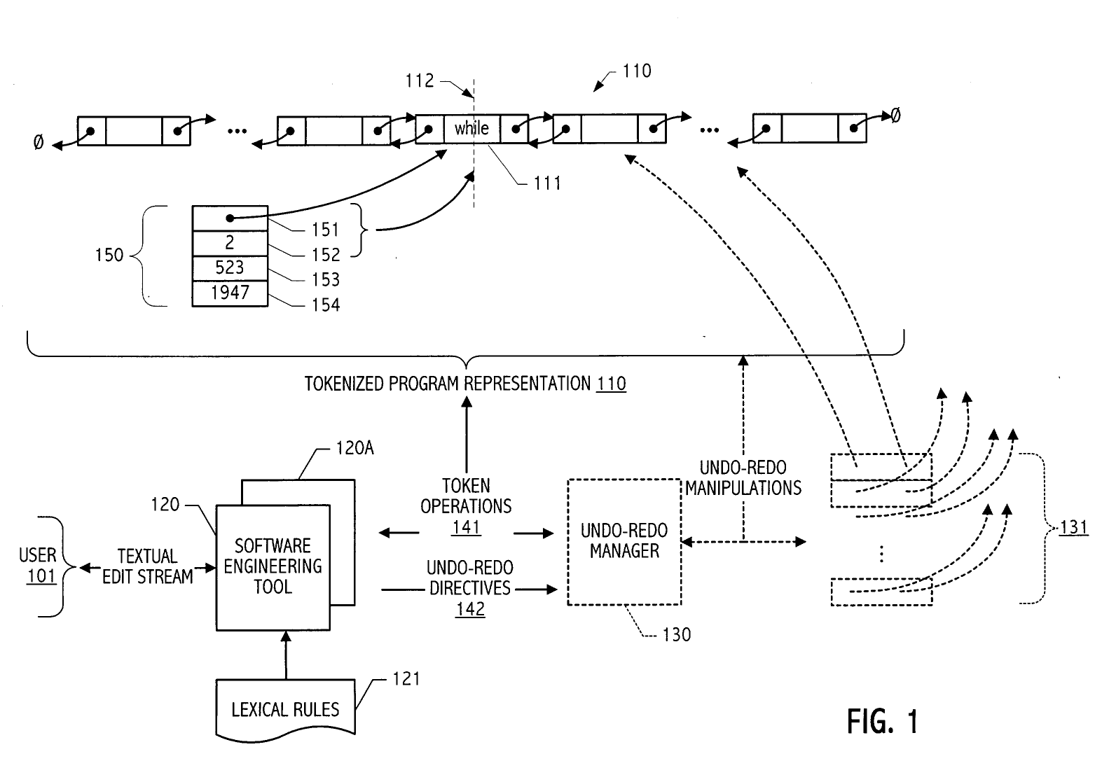

FIG. 1 depicts operation of one or more software engineering tools (e.g., software engineering tools 120 and 120A) that operate on, maintain and/or traverse a tokenized representation of information, such as tokenized program representation 110. In FIG. 1, a doubly-linked list representation of tokenized program code is illustrated. Of course, any of a variety of variable-size structures that support efficient insertion and removal may be employed. For example, although the illustration of FIG. 1 suggests plural nodes configured in a doubly-linked list arrangement with textual information associated with each such node, other information and coding arrangements are possible. In some realizations, node-associated information may be encoded by reference, i.e., by a pointer identifying the associated information, or using a token code or label. In some variations, identical textual or other information content associated with different nodes may be encoded as multiple pointers to a same representation of such information. In some realizations, information may even be encoded in the body of a node's structure itself. Whatever the particular design choice, the illustrated doubly-linked list encoding provides a flexible way of representing the tokenized program content and provides a useful illustrative context.

In general, language-oriented properties can be separated from the list structure. For example, in the illustrated tokenized program representation 110, a character sequence (e.g., that corresponding to a computer program or portion thereof) is represented as a doubly-linked list of text strings, while the language (lexical) properties of the strings can be isolated from the list structure by storing references to associated strings in each node. In this way, structures and methods of manipulation can be implemented without bias to a particular language, and language-oriented behaviors can be implemented or supported in a modular fashion. In addition, multiple lexical contexts and/or embedded lexical contexts may be efficiently supported. In general, when a character sequence is stored or represented, the total amount of storage or memory employed can be substantially reduced by storing a pointers to an associated text string encoding and such encodings may be referenced by the various nodes that correspond to uses of a particular string (or token) in a given program representation. Storage for the text strings can be managed separately from the storage for the nodes. For example, when allocating a string for a new node (or token), existing strings may be checked to see if a corresponding string already exists. Strings corresponding to valid language tokens may be pre-allocated and indexed using a token identifier, hash or any other suitable technique.

In the illustration of FIG. 1, an insertion point representation (e.g., insertion point 150) is used to identify a particular point in the tokenized list structure at which edit operations operate. The insertion point may be manipulated by navigation operations, as a result of at least some edit operations, or (in some configurations) based on operations of a programming tool such as a source level debugger. A variety of insertion point representations are suitable, including insertion point representations that encode text offsets and/or total buffer size. The illustrated insertion point representation includes an encoding of token coordinates using token pointer 151 and offset 152. Using such a token-coordinates representation, a particular position in tokenized program representation 110, e.g., position 112 immediately before the character “i” in the text string representation corresponding to language token 111, is identified. The insertion point representation is maintained consistent with edit operations and navigation operations. In a given insertion point representation, additional information may also be encoded (and maintained) to facilitate operations of various software engineering tools. In particular, the illustrated representation includes a further character-coordinates representation, e.g., total text offset 153 into tokenized program representation 110, and a total buffer length encoding 154.

Many variations on the illustrated insertion point representation are envisioned. For example, in some exploitations, the additional character-coordinates representation may be unnecessary and may be omitted, disabled or unused. Similarly, a total buffer length encoding is optional for some exploitations. In addition, while straightforward implementations tend to represent text offsets as positive offsets from a lowest order base position (e.g., a positive offset from a beginning of string or beginning of token position), other variations are possible. For example, offsets (including negative offsets) from other positions such as an end of string or token position may be employed. More generally, any arbitrary base/offset convention may be employed, including from arbitrary or predetermined way points in a program representation. These and other variations may fall within the scope of certain claims that follow. Nonetheless, for clarity of illustration, the description that follows focuses on a straightforward zero-base and positive offset convention.

Furthermore, insertion point representations are susceptible to a variety of suitable encodings including as data structures that identically or non-identically represent some or all of the data of the illustrated insertion point representation 150. For example, data may be encoded in, or in association with, an insertion point representation to improve the efficiency of manipulations of the tokenized program representation. Similarly, certain aspects of the represented data may be hierarchically organized and/or referenced by value to facilitate transformations and/or undo-redo caching that may be employed in some realizations. For purposes of this description, any of a variety of insertion point encodings are suitable.

As illustrated in FIG. 1, one or more software engineering tools may operate on the contents of tokenized program representation 110 using token operations 141. Illustrative token operations include insertion, removal, and/or replacement of tokens in or from tokenized program representation 110. Lexical rules 121 facilitate decomposition, analysis and/or parsing of a textual edit stream, e.g., that supplied through interactions with user 101, to transform textual operations into token oriented operations. In general, any of a variety of lexical analysis techniques may be employed. However, in some implementations, tokens are updated incrementally after each user action (for example, after each keystroke) using incremental techniques such as those described in U.S. Pat. No., 5,737,608 to Van De Vanter, entitled “PER KEYSTROKE INCREMENTAL LEXING USING A CONVENTIONAL BATCH LEXER,” the entirety of which in incorporated herein by reference. Other lexical analysis techniques may be employed in a given implementation. Whatever the techniques employed, a textual edit stream will, in general, result in updates to tokenized program representation 110 that can be defined in terms of insertions, deletion and/or replacements of one or more tokens thereof. The description that follows describes insertion, deletion and replacement operations and associated representations that facilitate efficient handling of such operations.

In some realizations, an optional undo-redo manager 130 maintains a collection 131 of undo-redo objects or structures that facilitate manipulations of tokenized program representation 110 to achieve the semantics of undo and redo operations. In general, such an undo-redo manager is responsive to undo-redo directives 142 supplied by software engineering tool 120 and interacts with tokenized program representation 110 and the undo-redo objects in accordance therewith. Typically, undo-redo directives are themselves responsive to user manipulations, although other sources (such as from automated tools) are also possible. In the illustration of FIG. 1, individual undo-redo structures identify respective nodes of the tokenized program representation (including those corresponding to inserted or removed tokens) to facilitate undo and redo operations. Suitable undo-redo implementations and support are described in greater detail in co-pending U.S. patent application Ser. No. XX/xxx,xxx {Atty. Docket No. 004-6207, entitled “UNDO/REDO TECHNIQUE FOR TOKEN-ORIENTED REPRESENTATION OF PROGRAM CODE,” naming Van De Vanter and Urquhart as inventors and filed on even date herewith} and Ser. No. XX/xxx,xxx {Atty. Docket No. 004-6208, entitled “UNDO/REDO TECHNIQUE WITH INSERTION POINT STATE HANDLING FOR TOKEN-ORIENTED REPRESENTATION OF PROGRAM CODE,” naming Van De Vanter and Urquhart as inventors and filed on even date herewith}, each of which is incorporated herein by reference.

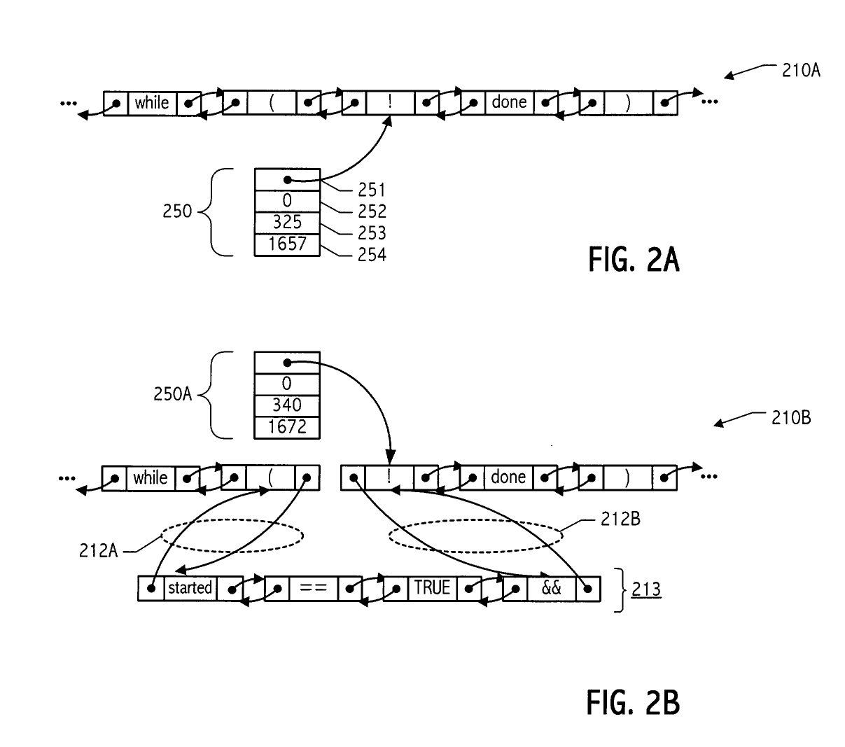

FIGS. 2A and 2B illustrate successive states of a tokenized program representation that is manipulated in response to an insert operation (i.e., an operation that inserts one or more tokens). In FIG. 2A, we illustrate a partial state 210A of the tokenized program representation in which program code has been tokenized in accordance with lexical rules appropriate for a programming language, such as the C programming language. For simplicity of illustration, only a partial state corresponding to a fragment,

. . . while (!done) . . . ,

of the total program code is illustrated and the illustrated insertion adds a token chain corresponding to an additional predicate.

Insertion point representation 250 depicts an insertion point state corresponding to a position immediately preceding the “!” character as it exists prior to operation of the illustrated insertion. In particular, insertion point representation 250 includes a token-coordinates representation, i.e., pointer 251 identifies the corresponding node of the tokenized program representation and text offset 252 identifies the offset (in this case, offset=0) thereinto. Additional optional fields 253 and 254 encode a character-coordinates representation and total buffer length respectively.

Turning to FIG. 2B, we illustrate the result of an insertion into the tokenized program representation (pre-insertion state 210A) of four additional tokens (fragment 213 ) corresponding to user edits of the program code. In the illustration of FIG. 2B, updates to bi-directional pointers 212A and 212B effectuate the token insertion into the tokenized program representation resulting in post-insertion state 210B. A post insertion state 250A of the insertion point is maintained in correspondence with the insertion. Based on the illustrated insertion point convention and the particular insertion illustrated, no update to token identifier or text offset is necessary. However, additional fields that encode a character-coordinates representation and total buffer length are updated in accordance with the particulars of inserted fragment 213. In the illustrated configuration, any between-token whitespace is excluded in the calculation of updated character coordinates and total buffer length although other conventions may be employed in other implementations. Simple arithmetic updates based in the length of strings corresponding to inserted fragment 213 are suitable.

Of note, N substrings can be inserted in O(N) time into an arbitrary sequence of characters of arbitrary length stored as illustrated above. Insertion of a single node into the list takes O(1) time once a reference to the insertion point is known and such an insertion point is continuously maintained by an editor or other tool. Therefore, when an linear sequence of characters is stored as a doubly-linked list of strings, insertion of new characters can be implemented as an insertion of one or more list nodes. Computational costs of insertion are advantageously independent of total buffer length.

Based on the description above, persons of ordinary skill in the art will appreciate a variety suitable functional implementations to support the above-described token insertion. The exemplary code that follows illustrates one such suitable functional implementation.

// Represents a token in a doubly linked list.
// There are sentinel tokens at each end of the list, so that
// no pointers in tokens which are proper members of the list
// are null.
class Token {

public Token next;
public Token previous;
public String text;
. . . .

}
// Represents a stream of tokens, represented as a doubly linked
// list with beginning and ending sentinels. The total number of
// characters in the stream is cached at all times.
public class TokenStream {

Token bos;
Token eos;
int length;
. . .

}
// Representsa character position where editing operations may be
// performed in a doubly linked list of token nodes. The position
// is recorded in two formats:
// - a (token, offset) pair, and
// - an integer offset that represents the position in characters
// from the beginning of the stream.
class Point {

public TokenStream stream;
public Token token;
public int tokenOffset;
public int streamOffset;
. . .

}
// Represents a stream of tokens, represented as a doubly linked
// list with beginning and ending sentinels. The total number of
// characters in the stream is cached at all times.
public class TokenStream {

. . .
// Method for inserting tokens into a doubly linked list at
// a point between tokens.
// Precondition:
// - <point> refers to the beginning of a token in a doubly
// linked list of Tokens with sentinels, or possibly to the
// ending sentinel. <point>.tokenOffset thus must be 0.
// - <first> refers to the first of a doubly linked list of at
// least one Token, which are not in the list referred to by
// <point>
/// - <last> refers to the last of these tokens
// Postcondition:
// - <point> points to the same position.
// - The tokens beginning with <first> and ending with <last>
// are in the token list, which is otherwise unchanged,
// immediately prior to the token pointed to by <point>.
// - The cached values in <point> for character
// offset and buffer length are updated.
public void insert(Token first, Token last, Point point) {

Token lastBefore = point.token.previous;
Token firstAfter = point.token;
lastBefore.next = first;
first.previous = lastBefore;
last.next = firstAfter;
firstAfter.previous = last;
int insertedLength = computeLength (first,last);
length += insertedLength;
return;

}
. . .

}

The preceding code is object-oriented and is generally suitable for use in a implementation framework such as that presented by the Java Foundation Classes (JFC) integrated into Java 2 platform, Standard Edition (J2SE). However, other implementations, including procedural implementation and implementations adapted to design constraints of other environments, are also suitable.

Arithmetic manipulations to support offset updates (including character coordinates offsets) and total buffer length updates are simple and suitable modifications corresponding to any particular base/offset convention employed will be appreciated based on the description herein. In general, the character-coordinates of a current insertion point can be determined in O(1) time in implementations that maintain such additional information through simple arithmetic adjustments consistent with the character length of fragments inserted or removed from the tokenized program representation.

Repositioning the insertion point generally involves traversing the tokenized program representation forward or backward from a current insertion point, one node at a time, calculating a character coordinates adjustment at each step by examining the length of the node's corresponding string. Of note, such a repositioning operation is O(N) in the size of the move, not the size of the program representation. In some implementations, repositioning the insertion point can be further optimized by comparing the desired insertion point position with various way points in the tokenized program representation. For example, desired insertion point position may be compared with the current insertion point, with the beginning of program (e.g., character-coordinate 0) and/or with the end of program (e.g., character-coordinate equal to total character count). Depending on the desired insertion point position, a closest one may be selected as a base for traversal to further improve the performance of repositioning operations.

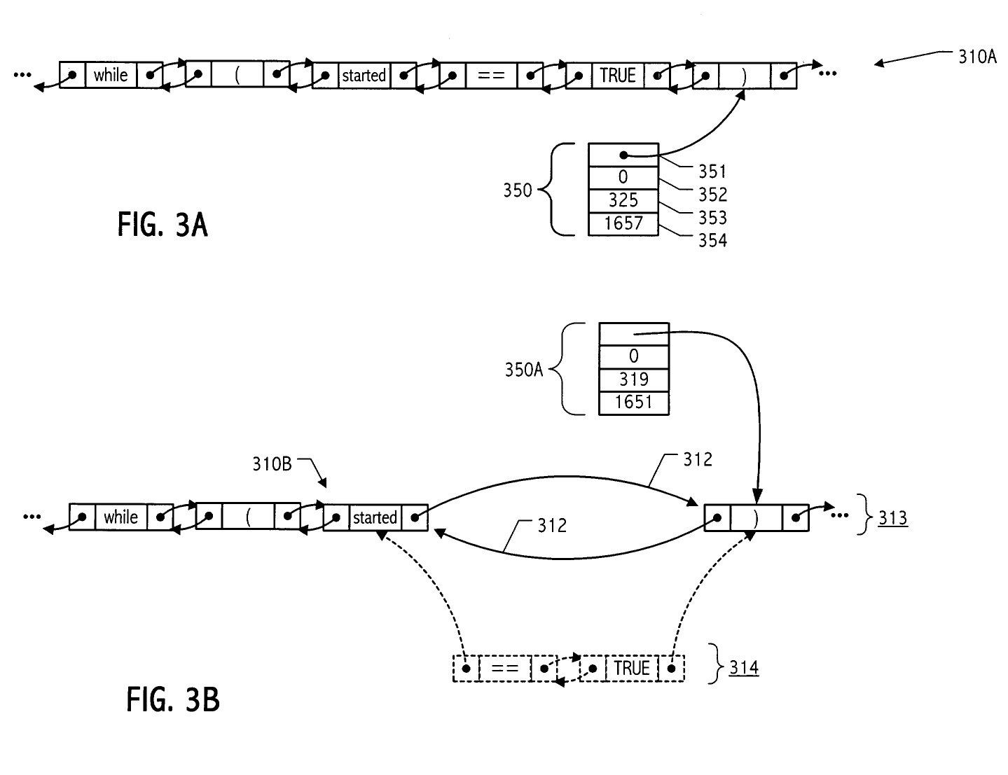

FIGS. 3A and 3B illustrate successive states of a tokenized program representation that is manipulated in response to a remove operation (i.e., an operation that removes one or more tokens) and successive undo and redo operations. As before, FIG. 3A illustrates an initial partial state 310A of a tokenized program representation. For simplicity, only a partial state corresponding to a fragment,

. . . while (started==TRUE) . . . ,

of the total program code is illustrated and the illustrated deletion removes tokens corresponding to potentially superfluous code.

Insertion point representation 350 depicts an insertion point state corresponding to a position immediately preceding the “)” character as it exists prior to the operation of the illustrated removal. In particular, insertion point representation 350 includes a token-coordinates representation, i.e., pointer 351 identifies the corresponding node of the tokenized program representation and text offset 352 identifies the offset (in this case, offset=0) thereinto. Additional optional fields 353 and 354 encode a character-coordinates representation and total buffer length respectively.

FIG. 3B then illustrates the result of a removal from the tokenized program representation (i.e., from pre-removal state 310A) of two tokens (fragment 314) corresponding to user edits of the program code. In the illustration of FIG. 3B, bi-directional pointers 312 are updated to bridge the excised fragment 314. A post insertion state 350A of the insertion point is maintained in correspondence with the removal. Based on the illustrated insertion point convention and the particular removal illustrated, no update to token identifier or text offset is necessary. However, additional fields that encode a character-coordinates representation and total buffer length are updated in accordance with the particulars of excised fragment 314. In the illustrated configuration, between-token whitespace is included in the calculation of updated character coordinates and total buffer length although other conventions may be employed in other implementations. Simple arithmetic updates based in the length of strings corresponding to excised fragment 314 are suitable. The exemplary code that follows illustrates one suitable functional implementation of the above-described token removal.

// Represents a stream of tokens, represented as a doubly linked
// list with beginning and ending sentinels. The total number of
// characters in the stream is cached at all times.
public class TokenStream {

. . .
// Method for deleting tokens from a doubly linked list
// Precondition:
// - <first> and <last> point to tokens in a doubly linked
// list of Tokens with sentinels
// - The token <first> is either the same as, or prior to
// the token <last> in the list
// - <point> refers to the beginning of the token just
// after <last>
// Postcondition:
// - The tokens beginning with <first> and ending with
// <last> are no longer in the token list, which is
// otherwise unchanged.
// - The cached values in <point> for character
// offset and buffer legnth are updated.
public void delete (Token first, Token last, Point point) {

Token lastBefore = first.previous;
Token firstAfter = last.next;
lastBefore.next = firstAfter;
firstAfter.previous = lastBefore;
int deletedLength = computeLength (first, last);
point.streamOffset −= deletedLength;
length −= deletedLength;
return;

}
. . .

}

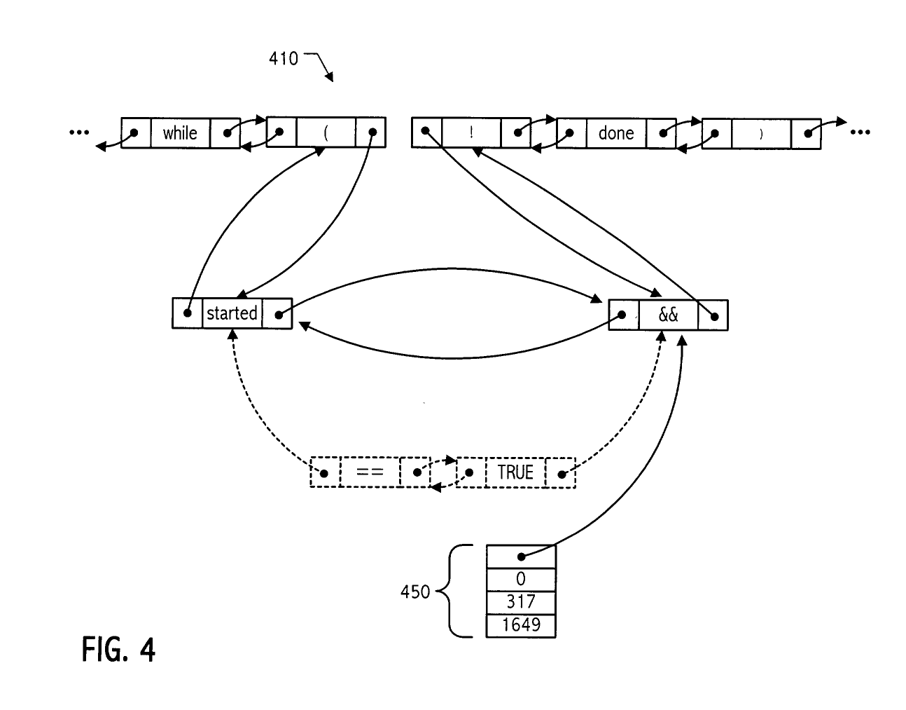

While the previously described insertion and removal operations have been illustrated primarily in the context of a single operation, based on the description herein, persons of ordinary skill in the art will recognize that in a typical editing session, or for that matter, in the course of operation another programming tool, multiple insertions and removals of program fragments will occur. Indeed, large number of such insertions and removals will occur and, in general, can be represented as an ordered set of such operations. In some cases, one operation (e.g., a removal) will operate on results of the previous operation (e.g., an insertion). FIG. 4 represents a tokenized program representation that illustrates results of an insertion operation that is followed by a removal operation that targets a portion of the previously inserted code. A partial state 410 of the tokenized program representation and corresponding insertion point representation 450 are illustrated.

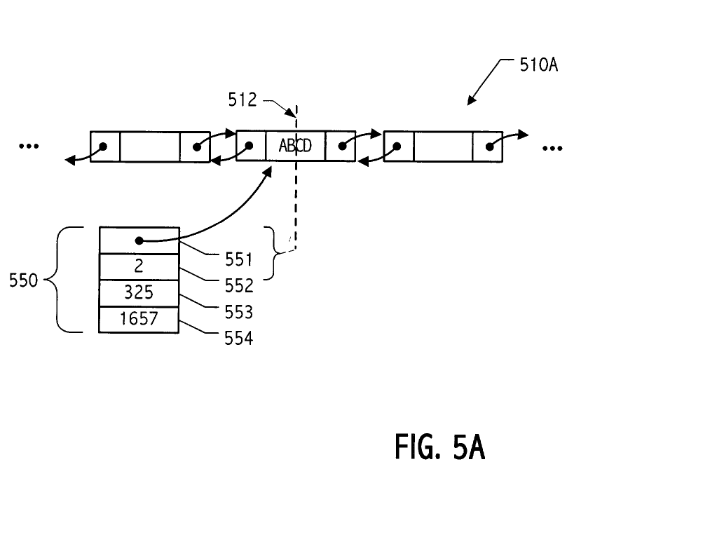

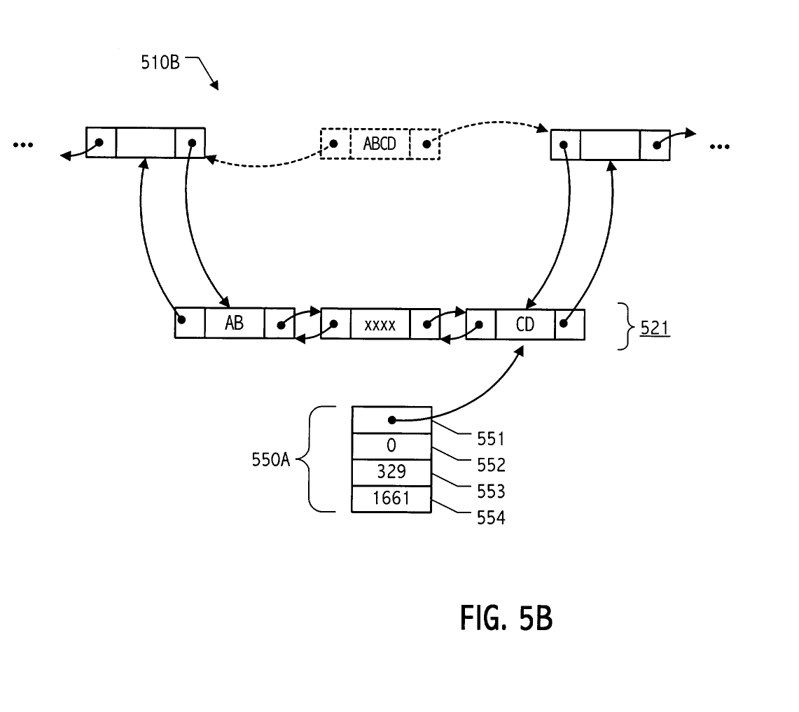

FIGS. 5A and 5B illustrate various successive states of a tokenized program representation that is manipulated in response to a replace operation (i.e., an operation that replaces, in the tokenized representation, a first set of one or more tokens with a second set). As before, FIG. 5A illustrates an initial partial state 510A of a tokenized program representation as well as a corresponding state 550 of the insertion point representation. The illustrated insertion point state corresponds to a position 512 (encoded in field 552 as offset=2) between characters “B” and “C” of the token identified by field 551. As before, fields 553 and 554 encode a character-coordinates representation of the insertion point state and a total buffer count, respectively.

Turning to FIG. 5B, we illustrate replacement of a single token fragment <ABCD> with a three token fragment <AB> <xxxx> <CD>, illustrated as fragment 521. Operation of such a replace operation is similar to that previously illustrated with respect to an insertion operation except that, rather than operating at a particular insertion point, the splicing in of tokenized program code fragment 521 displaces a fragment of the previous program representation state. In the illustrated replacement, the token coordinates are updated to reflect the new token and offset (i.e., 0) that continues to identify an insertion point immediately preceding the character “C”.

Although the preceding example has illustrated operation of a replacement operation in the context of a three node for one node replacement, persons of ordinary skill in the art will recognize that the illustrated techniques are more generally applicable to displaced and replacement fragments of any size. Similarly, persons of ordinary skill in the art will recognize that semantics of an insert operation that-splits a pre-existing token may be efficiently implemented as a replace operation. Functional code to implement such a replace operation follows:

// Represents a stream of tokens, represented as a doubly linked
// list with beginning and ending sentinels. The total number of
// characters in the stream is cached at all times.
public class TokenStream {

. . .
// Method for replacing tokens in a doubly linked list
// Precondition:
// - <oldFirst> and <oldLast> point to tokens in a doubly
// linked list of Tokens with sentinels
// - the token <oldFirst> is either the same as, or prior to
// the token <oldLast> in the list
// - <point> refers to a position within the range <oldFirst>
// through <oldLast>
// - <newFirst> refers to the first of a doubly linked list of
// at least one Token, which are not in the list referred
// to by <oldFirst> and <oldLast>; <newLast> refers to the
// last of these tokens.
// Postcondition:
// - The tokens beginning with <newFirst> and ending with
// <newLast> are in the token list in place of the tokens
// beginning with <oldFirst> and ending with <oldLast>.
// - The token list is otherwise unchanged
// - <point> refers to the position in the stream in token
// <newPointToken> at character offset <newPointOffset>.
public void replace (Token oldFirst, Token oldLast,

Point point, Token newFirst,
Token newLast, Token newPointToken,
int newPointOffset) {

| Token lastBefore = oldFirst.previous; | |
|---|---|
| Token firstAfter = oldLast.next; | |
| lastBefore.next = newFirst; | |
| newFirst.previous = lastBefore; | |
| newLast.next = firstAfter; | |
| firstAfter.previous = newLast; | |
| int streamOffsetChange = | computeDistance (newFirst, |
| | newPointToken, newPointOffset) − |
| | computeDistance(oldFirst, |
| | point.token, point.tokenOffset); |
| int streamLengthChange = | computeLength(newFirst, |
| | newLast) − |
| | computeLength(oldFirst, |
| | oldLast); |

point.token = newPointToken;
point.tokenOffset = newPointOffset;
point.streamOffset += streamOffsetChange;
length += streamLengthChange;
return;

}
. . .

}

Exemplary Editor Implementation

In general, techniques of the present invention may be implemented using a variety of editor implementations. Nonetheless, for purposes of illustration, the description of exemplary editor implementations in U.S. Pat. No. 5,737,608, entitled “PER-KEYSTROKE INCREMENTAL LEXING USING A CONVENTIONAL BATCH LEXER” is incorporated herein by reference. In particular, while the preceding code implements token operations, persons of ordinary skill in the art will recognize that editor and/or programming tools implementations may often include operations that operate at a level of abstraction that corresponds to character manipulations. Such character-oriented manipulations typically affect the state of an underlying token-oriented representation and such state changes can be effectuated using token operations such as the insertion, removal and replacement operations described herein. To generate sequences of token-oriented operations that correspond to character manipulations, incremental lexing techniques described in the '608 patent may be employed in some realizations.

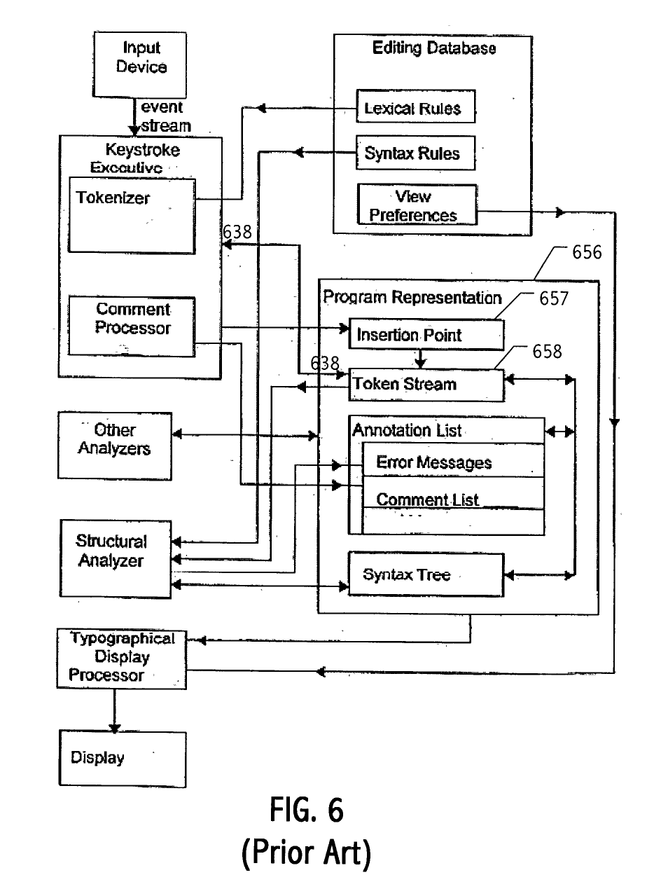

FIG. 6 depicts interactions between various functional components of an exemplary editor implementation patterned on that described in greater detail in the '608 patent. In particular, techniques of the present invention are employed to implement program representation 656, and particularly token stream representation 658 and insertion point representation 657, to support efficient edit and repositioning operations. By implementing operations 638, including insert, remove and/or replace operations, on token stream representation 658 as described above, such efficiency is provided. Based on the description herein, including the above-incorporated description, persons of ordinary skill in the art will appreciate a variety of editor implementations that may benefit from features and techniques of the present invention.

While the invention has been described with reference to various embodiments, it will be understood that these embodiments are illustrative and that the scope of the invention is not limited to them. Many variations, modifications, additions, and improvements are possible. In particular, a wide variety of lexical contexts may be supported. For example, while a lexical context typical of program code has been illustrated, other lexical contexts such as those appropriate to markup languages, comments, even multimedia content may be supported. Similarly, although much of the description has focused on functionality of an editor, the techniques described herein may apply equally to other interactive or even batch oriented tools. While lexical analysis of textual content has been presumed in many illustrations, persons of ordinary skill in the art will recognize that the techniques described herein also apply to structure-oriented editors and to implementations that provide syntactic, as well as lexical, analysis of content.

More generally, plural instances may be provided for components described herein as a single instance. Boundaries between various components, operations and data stores are somewhat arbitrary, and particular operations are illustrated in the context of specific illustrative configurations. Other allocations of functionality are envisioned. Structures and functionality presented as discrete in the exemplary configurations may be implemented as a combined structure or component. These and other variations, modifications, additions, and improvements may fall within the scope of the invention as defined in the claims that follow.

What is claimed is:

1. A software engineering tool encoded in one or more computer readable media as instructions executable to represent program code as a doubly-linked list of lexical tokens and to maintain, consistent with operations thereon, both a token-coordinates representation and a character-coordinates representation of an insertion point.

2. The software engineering tool of claim 1,
wherein the operations include insertion point repositioning operations.

3. The software engineering tool of claim 1,
wherein the operations include edit operations.

4. The software engineering tool of claim 3, wherein the edit operations include one or more of:
insertion operations;
removal operations; and
replacement operations.

5. The software engineering tool of claim 1,
wherein the token-coordinates representation identifies both a particular one of the lexical tokens and a substring offset into a substring associated with the particular lexical token.

6. The software engineering tool of claim 1,
wherein the character-coordinates representation identifies a character offset into the program code.

7. The software engineering tool of claim 6,
wherein the character offset is a total character offset from a start of buffer position in the program code.

8. The software engineering tool of claim 6,
wherein the character offset is from a particular position in the program code.

9. The software engineering tool of claim 1,
wherein, coincident with movement of the insertion point to a new position in the program code, the maintaining includes traversing from a particular position in the doubly-linked list toward the new position, and updating both the token-coordinates representation and character-coordinates representation of the insertion point in correspondence therewith.

10. The software engineering tool of claim 9,
wherein the particular position corresponds to the insertion point.

11. The software engineering tool of claim 9,
wherein the instructions are further executable to maintain a representation of total character count at an end of the represented program code; and
wherein the particular position corresponds to one of:
a beginning of represented program code,
the insertion point, and
the end of the represented program code,
selected based on comparison with the new position to generally minimize computational overhead associated with the scanning and updating.

12. The software engineering tool of claim 9,
wherein computational overhead associated with the scanning and updating is generally insensitive to length of the represented program code, and instead exhibits no greater than O(N) scaling behavior, where N corresponds to scale of displacement from the particular position to the new position.

13. The software engineering tool of claim 1,
wherein the instructions are further executable to maintain, consistent with each operation that modifies the program code, a total character count.

14. The software engineering tool of claim 1, configured as one or more of:
an editor;
a source level debugger;
a class viewer;
a profiler; and
an integrated development environment.

15. The software engineering tool of claim 1,
wherein the one or more computer readable media are selected from the set of a disk, tape or other magnetic, optical, or electronic storage medium and a network, wireline, wireless or other communications medium.

16. A method of providing character-oriented coordinates for an insertion point in an edit buffer represented as a sequence of lexical tokens, the method comprising:
representing the edit buffer as a doubly-linked list of nodes, each node corresponding to a respective one of the lexical tokens; and
representing the insertion point in the edit buffer, the insertion point representation identifying:
(i) a particular one of the lexical tokens corresponding to the insertion point; and
(ii) a total character offset of the insertion point into the edit buffer.

17. The method of claim 16,
wherein the insertion point representation further identifies:
(iii) a string offset into a string associated with the particular lexical token.

18. The method of claim 16, further comprising:
maintaining, coincident with an operation that modifies contents of the edit buffer, the insertion point representation.

19. The method of claim 18,
wherein the operation that modifies contents of the edit buffer includes one or more of an insert, remove, split, join or replace operation performed at the insertion point.

20. The method of claim 16, further comprising:
maintaining, coincident with movement of the insertion point to a new position, the insertion point representation.

21. The method of claim 20,
wherein the maintaining includes scanning from a particular position in the doubly-linked list toward the new position, and updating the identification of both the particular lexical token and the total character offset.

22. The method of claim 21,
wherein the particular position corresponds to the insertion point.

23. The method of claim 21,
further comprising maintaining a representation of total character count for the edit buffer; and
wherein the particular position corresponds to one of:
a beginning of the edit buffer,
the insertion point, and
an end of the edit buffer,
selected based on comparison with the new position to generally minimize computational overhead associated with the scanning and updating.

24. The method of claim 21, further comprising:
updating, consistent with each operation that modifies contents of the edit buffer, a representation of total character count.

25. One or more computer readable media encoding a data structure that represents contents of an edit buffer as a sequence of lexical tokens, the encoded data structure comprising:
a doubly linked list of nodes;
token representations each corresponding to at least one respective node of the list, wherein at least some of the token representations have associated string encodings; and
an insertion point representation identifying, for the insertion point, both a particular one of the lexical tokens and a total character offset into the edit buffer.

26. The encoded data structure of claim 25,
wherein the insertion point representation further identifies a character offset into a string associated with the particular lexical token.

27. The encoded data structure of claim 25, embodied as a software object that defines at least one operation that repositions the insertion point,
wherein performance of the repositioning operation updates both the particular lexical token and the total character offset.

28. The encoded data structure of claim 27,
wherein performance of the repositioning operation includes traversing from a particular position in the doubly-linked list toward a new position, and updating both the particular lexical token and the total character offset in correspondence therewith.

29. The encoded data structure of claim 28,
wherein the particular position corresponds to the insertion point.

30. The encoded data structure of claim 28,
further comprising a representation of total character count for the edit buffer,
wherein the particular position corresponds to one of:
a beginning of the edit buffer,
the insertion point, and
an end of the edit buffer,
selected based on comparison with the new position to generally minimize computational overhead associated with the scanning and updating.

31. The encoded data structure of claim 28,
wherein computational overhead associated with the scanning and updating is generally insensitive to length of the edit buffer, and instead exhibits no greater than O(N) scaling behavior, where N corresponds to scale of the repositioning from the particular position to the new position.

32. The encoded data structure of claim 25,
wherein the total offset is explicitly represented.

33. The encoded data structure of claim 26,
wherein the total offset is represented as a value derived from plural explicitly represented values including the character offset.

34. The encoded data structure of claim 25, embodied as a software object that defines edit operations on contents of the edit buffer,
wherein, consistent with semantics thereof, each of the edit operations performed on the edit buffer updates a representation of total character count for the edit buffer contents.

35. The encoded data structure of claim 25,
wherein the one or more computer readable media are selected from the set of a disk, tape or other magnetic, optical, or electronic storage medium and a network, wireline, wireless or other communications medium.

36. A method of supporting access by one or more software engineering tools to program code, wherein at least one such tool operates on the program code as a token sequence and at least one such tool operates on the program code as a character sequence, the method comprising:
maintaining a representation of the program code as a doubly-linked list of nodes, each node corresponding to a lexical token thereof; and
responsive to repositioning of an insertion point, updating a representation thereof that identifies:
a particular one of the lexical tokens;
a character offset into a string associated with the particular lexical token; and
a total character offset into the program code.

37. The method of claim 36,
wherein the repositioning includes traversing from a particular position in the doubly-linked list toward a new position and updating the insertion point representation in correspondence therewith.

38. The method of claim 37,
wherein the particular position corresponds to the insertion point.

39. The method of claim 37, further comprising:
maintaining a representation of total character count for the program code,
wherein the particular position corresponds to one of:
a beginning of the program code,
the insertion point, and
an end of the program code,
selected based on comparison with the new position to generally minimize computational overhead associated with the scanning and updating.

40. The method of claim 36,
wherein the tool that operates on the program code as a token sequence and the tool that operates on the program code as a character sequence are different tools.

41. The method of claim 36,
wherein the tool that operates on the program code as a token sequence and the tool that operates on the program code as a character sequence are a same tool.

42. An apparatus comprising:
storage for a computer readable encoding of an edit buffer represented as a sequence of lexical tokens; and
means for representing an insertion point in the edit buffer, the insertion point identifying both a particular one of the lexical tokens and a total character offset into the edit buffer.

43. The apparatus of claim 42,
wherein the insertion point representation means further identifies a substring offset into a substring associated with the particular lexical token.

44. The apparatus of claim 42, further comprising:
means for maintaining a total character count in correspondence with an operation that modifies contents of the edit buffer.

45. The apparatus of claim 42, further comprising:
means for updating the insertion point in correspondence with a repositioning operation.
